(19) United States
(12) Patent Application Publication
(10) Pub. No.: US 2024/0271063 A1
(43) Pub. Date: Aug. 15, 2024

(54) Skin Safe, One-Step Artists Brush Cleaner for Oil and Other Paint Applications

(71) Applicants: LeeAnn Rene Abrams, Sun Prairie, WI (US); Trisha Marie Lundquist, Sun Prairie, WI (US)

(72) Inventors: LeeAnn Rene Abrams, Sun Prairie, WI (US); Trisha Marie Lundquist, Sun Prairie, WI (US)

(21) Appl. No.: 18/109,820

(22) Filed: Feb. 14, 2023

(51) Int. Cl. C11D 3/382; C11D 1/14; C11D 11/00

(52) U.S. Cl. CPC C11D 3/382; C11D 1/143; C11D 2111/12

(57) ABSTRACT

Disclosed is a skin-safe, non-drying, cream mixture for thinning, emulsifying and dispersing pigment mixed in oils or other binders from artists tools, mainly brushes, without the addition of a traditional hydrocarbon solvents, either plant or petroleum based.

### BACKGROUND/SUMMARY

### Field of the Invention

The present disclosure relates to a skin-safe composition for cleaning oil or other paint from brushes and artist tools in one step.

### Background

Artists have long been struggling with toxic or ineffective methods to clean oil paint from their brushes and tools. Current technologies use systems that usually require a solvent, either plant or petroleum based, to “thin” the oil paint before cleaning with soap and water. If the products don't use a solvent, they are an inefficient cleansing system of soap and water.

With artists paying attention to their health and their impact on the environment, there is a need for a skin safe, non-solvent, biodegradable yet effective brush cleaner for artists, especially those who use traditional oil paint.

Historically, solvents have been turpentine, the modified product Terpenoid; a supposedly non-scented version, or mineral spirits. All these substances come with health and safety concerns from skin and lung exposures to storage and combustion issues stemming from their extreme flammability. Additionally, turpentine tends to dry to a sticky consistency if left on a brush or tool for too long. Traditional oil paint is hydrophobic and cleaning with soap and water usually creates a gummy mess. Dried oil paint is totally impervious to any attempt to clean with just soap.

New “Natural” solvents/thinners have been introduced in recent years, based on citrus oils, but these products are banned in several states due to their volatile organic compounds (VOC) content. Citrus oils can also be phototoxic to skin and sensitizing if used frequently.

US Patent U.S. Pat. No. 5,472,631A describes a method of using a mixture of a common vegetable oil and commercially available dish detergent to clean brushes. While this method apparently accomplishes cleaning uncured oil paint from brushes, it specifically does not work on cured paint due. The author is also not specific about the oil to be used, listing several acceptable ones. But we have found only a specific type of vegetable oil works on cured paint. Notably, the author does not seem to be concerned that a user could use chemicals known to cause skin sensitivities, such as abietic acid, one of a list of acceptable anionic agents the author mentions. Also, commercially available dish detergent is made up of a high amount of water along with emulsifiers and surfactants. It is well known that oil paint does not mix with water and using dish detergent could necessitate multiple attempts to accomplish a clean brush.

### SUMMARY

The embodiments of the disclosure describe the formulation of a substance that will emulsify and encapsulate paint to be removed by rinsing with water. This formulation was made specifically for oil based paint but will work on acrylic based paint. This formulation will work on both wet and, with a wait-period, dried oil, or acrylic paint. This formulation will not dry out if it sits for a significant amount of time. In usage trials, the formulation was left on a brush for 4 months before rinsing with water with no adverse effects noted. Additionally, if the artist is so inclined, brushes and tools can be rinsed into a bucket where the pigment will precipitate out of the solution and collect at the bottom. After which, the water and biodegradable surfactants can be easily poured off and the pigment collected for safe disposal. This formulation is made specifically to be mild on bare skin.

### DRAWINGS

Not Applicable

### DESCRIPTION

### Detailed Description of the Invention

The invention is a skin-safe, creamy substance comprised of vegetable oil, emulsifiers, surfactants, essential oil and a preservative. It is used to mix with paint on brushes to cause the binders and pigment to be fully removed from bristles using only water.

The invention is comprised of the following ingredients combined in the following steps in order:

Phase one comprises of 20-50% monounsaturated vegetable oil and 1-10% of a saturated long-chain fatty acid heated together until liquid.

Phase two comprises of 20-50% anionic surfactant powder that is comprised of sulfonic acid and a coconut derived fatty ester. This is mixed with 20-50% non-ionic, hydrophilic, vegetable derived emulsifier. These two items are blended and then added to phase one. The mentioned surfactant is preferable to other surfactants due to its larger micelle size relative to the stratum corneum, and its slightly acidic PH of 5.5-6 and is anecdotally known as baby foam due its mild but effective cleansing and moisturizing properties.

Phase three or Cool-Down Phase comprises of adding a 1-5% natural based broad-spectrum preservative and 1-5% essential oil.

The total mixture is blended until homogenous and packaged in appropriate packaging.

The chemical make-up of this product produces a creamy, thick, paint-like consistency cleansing product. The product's ultimate function is to mix with the oil/binders/pigments, thin the oil and pigments in the brush and emulsify them with the cleanser to be washed away with water. Leaving the brush clean and conditioned without toxic chemicals and solvents and without damaging the user's skin.

The combination of ingredients works symbiotically. The vegetable oil is used to thin the oil in the paint and make it easier to mix with the surfactants and emulsifiers. Anionic surfactants are used to encapsulate and lift particles (pigments) and the non-ionic emulsifier encapsulates oil molecules. This combination when mixed with oil paint creates a water-soluble lotion-like consistency mixture that easily rinses away.

This product can also be used on brushes with dried oil and acrylic paint. Dried oil or acrylic paint may need a resting time after cleaner is applied to be emulsified and softened for removal.

1. A one-step artist's paint brush and tool cleaner that works to remove both cured and uncured oil and acrylic paint on artist's brushes and tools and stays active without drying for a long period of time.

2. A one-step artist's paint brush and tool cleaner that is comprised of a total mixture of raw materials of which 20-50% is a monounsaturated vegetable oil.

3. A one-step artist's paint brush cleaner that is comprised of a total mixture of raw materials of which 20-50% is an anionic surfactant powder that is comprised of a sulfonic acid and a coconut derived fatty ester known to be gentle on skin.
